(19) United States
(12) Patent Application Publication
(10) Pub. No.: US 2025/0392543 A1
(43) Pub. Date: Dec. 25, 2025

(54) Handling of Packet Fragments

(71) Applicant: Arista Networks, Inc., Santa Clara, CA (US)

(72) Inventors: Vivek Subbarao, Bengaluru (IN); Arnab Das, Bengaluru (IN)

(21) Appl. No.: 18/754,084

(22) Filed: Jun. 25, 2024

(51) Int. Cl. H04L 45/74

(52) U.S. Cl. CPC H04L 45/74

(57) ABSTRACT

A network device may include packet processing circuitry and memory circuitry accessible by the packet processing circuitry to perform traffic processing operations. The packet processing circuitry may maintain, on the memory circuitry, a flow cache and a fragment mapping table. A leading fragment of an original un-fragmented packet may be used to provide an entry in the flow cache and to provide an entry in the fragment mapping table. The entry in the fragment mapping table and consequently the entry in the flow cache may be used to process one or more non-leading fragments of the original un-fragmented packet.

### BACKGROUND

A communications system can include network devices that are interconnected to form a network for conveying network traffic. Network devices can process the network traffic in the form of packets having Internet Protocol (IP) header information. To facilitate transmission across some network paths, some of these packets can be fragmented into smaller fragments.

### BRIEF DESCRIPTION OF THE DRAWINGS

FIG. 1 is a diagram of an illustrative networking system having one or more network devices that handle packet fragments in accordance with some embodiments.

FIG. 2 is a diagram of illustrative leading and non-leading packet fragments in accordance with some embodiments.

FIG. 3 is a diagram of an illustrative network device in accordance with some embodiments.

FIG. 4 is a diagram of illustrative packet processing circuitry configured to process a leading packet fragment in accordance with some embodiments.

FIG. 5 is a diagram of an illustrative flow cache maintained by packet processing circuitry in accordance with some embodiments.

FIG. 6 is a diagram of an illustrative fragment mapping table maintained by packet processing circuitry in accordance with some embodiments.

FIG. 7 is a diagram of illustrative packet processing circuitry configured to process a non-leading packet fragment after processing a leading packet fragment in accordance with some embodiments.

FIG. 8 is a diagram of illustrative packet processing circuitry configured to process a non-leading packet fragment prior to processing a leading packet fragment in accordance with some embodiments.

FIG. 9 is a diagram of illustrative packet processing circuitry configured to process a leading packet fragment after buffering a non-leading packet fragment in accordance with some embodiments.

FIG. 10 is a flowchart of illustrative operations for processing different types of packets in accordance with some embodiments.

FIG. 11 is a flowchart of illustrative operations for managing the fragment mapping table in accordance with some embodiments.

FIG. 12 is a flowchart of illustrative operations for facilitating the appropriate processing of non-leading packet fragments in accordance with some embodiments.

### DETAILED DESCRIPTION

A network may include interconnected network devices that convey network traffic between end hosts or generally between devices. Network traffic can sometimes be conveyed as separate fragments of a single original packet. Non-leading fragments of the packet (e.g., packet fragments having a non-zero value in their fragment offset field) may lack certain header information such as transport layer (Layer 4 or L4) header fields. Without more, the non-leading packet fragments may be improperly processed.

To resolve these issues and properly process non-leading fragments of the packet, a network device may maintain a flow cache and a fragment mapping table. The flow cache may include an entry usable to process the non-leading fragments but may not be identifiable using the header information of the non-leading fragments (e.g., due to the lack of L4 header fields). The fragment mapping table may include an entry that maps the existing L3 header information in the non-leading fragments to the flow cache table entry. Accordingly, the network device may process the non-leading fragments based on the flow cache entry identified by the entry in the fragment mapping table. Various details for processing packets (e.g., leading and non-leading packet fragments) are further described herein.

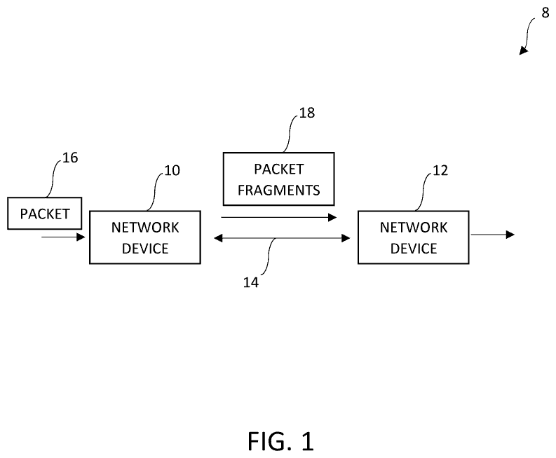

An illustrative networking system that includes one or more network devices configured to handle packet fragments (e.g., in the manner described above) is shown in FIG. 1. The networking system of FIG. 1 may include a communications network 8. Network 8 may be implemented to span across various geographical locations or generally be implemented with any suitable scope. As examples, network 8 may include, be, or form part of one or more local segments, one or more local subnets, one or more local area networks (LANs), one or more campus area networks, a wide area network, etc. In general, network 8 may include one or more wired portions with network devices interconnected based on wired technologies or standards such as Ethernet (e.g., using copper cables and/or fiber optic cables) and, if desired, one or more wireless portions implemented by wireless network devices (e.g., to form wireless local area networks (WLANs)). If desired, network 8 may include internet service provider networks (e.g., the Internet) or other public service provider networks, private service provider networks (e.g., multiprotocol label switching (MPLS) networks), and/or may include other types of networks such as telecommunication service provider networks.

Network 8 can include networking equipment forming a variety of network devices that interconnect and convey network traffic, e.g., in the form of frames, packets, etc., between devices such as end hosts. These network devices of network 8, such as network devices 10 and 12, may each be a switch (e.g., a multi-layer (Layer 2 and Layer 3) switch or a single-layer (Layer 2) switch), a bridge, a router, a gateway, a hub, a repeater, a firewall, a wireless access point, a network device serving other networking functions, management equipment that manages and controls the operation of one or more of these network devices, a network device that includes the functionality of two or more of these devices, or another type of network device.

Network devices of network 8 (e.g., network devices 10 and 12) may receive network traffic from one or more end hosts and may appropriately process the received network traffic to forward the network traffic to one or more end hosts. Host devices or host equipment that implement the end hosts of network 8 may include computers, servers, portable electronic devices such as cellular telephones and laptops, other types of specialized or general-purpose host computing equipment (e.g., running one or more client-side and/or server-side applications), network-connected appliances or devices that serve as input-output devices and/or computing devices in a distributed networking system, devices used by network administrators (sometimes referred to as administrator devices), network service or analysis devices, management equipment that manages and controls the operation of one or more of other end hosts and/or network devices, and/or other types of devices or equipment. In some instances, network devices of network 8 may receive and process network traffic that originates from (e.g., generated by) network devices (e.g., peer network devices) and/or from other network elements of network 8.

In the example of FIG. 1, network devices of network 8 such as network devices 10 and 12 may be configured to handle (e.g., process, transmit, and/or receive) packet fragments 18 fragmented from a single original packet 16. In particular, network device 10 may receive a packet 16 (e.g., an Internet Protocol (IP) packet that includes at least an IP header) that originated from an end host or another device in network 8. Network device 10 may be communicatively coupled to network device 12 via one or more network paths 14. Network paths 14 may include indirect paths (e.g., through other intervening network devices and/or networks of network 8) and/or direct paths (e.g., without intervening network devices). Each network path 14 may have a corresponding path maximum transmission unit (MTU). To comply with the path MTU of a network path 14 through which packet 16 is intended to be transmitted, network device 10 may split packet 16 into multiple packet fragments 18 (sometimes referred to as fragmented packets 18) that each have a size not exceeding the MTU of the path 14 conveying that fragment. Upon receiving packet fragments 18, network device 12 may process packet fragments 18 and transmit the processed packet fragments 18 (as fragments or as a defragmented packet) toward an end host or another device in network 8.

Configurations in which packet 16 is an Internet Protocol (IP) packet having at least an IP header (e.g., encapsulated by and/or encapsulating other protocol headers) and packet fragments 18 are IP packet fragments are sometimes described herein as an example. If desired, packet 16 may be other types of protocol data units and corresponding fragments 18 may be fragments of the other types of protocol data units.

In general, an original (unfragmented) packet 16 may be separated into any suitable number of packet fragments 18 (e.g., to satisfy the MTU of the network path(s) for conveyance). Accordingly, the payload data of the original packet 16 may be split amongst the payload data of the packet fragments 18. The original packet 16 may be split or fragmented into two types of fragmented packets: a leading packet fragment and one or more non-leading packet fragments.

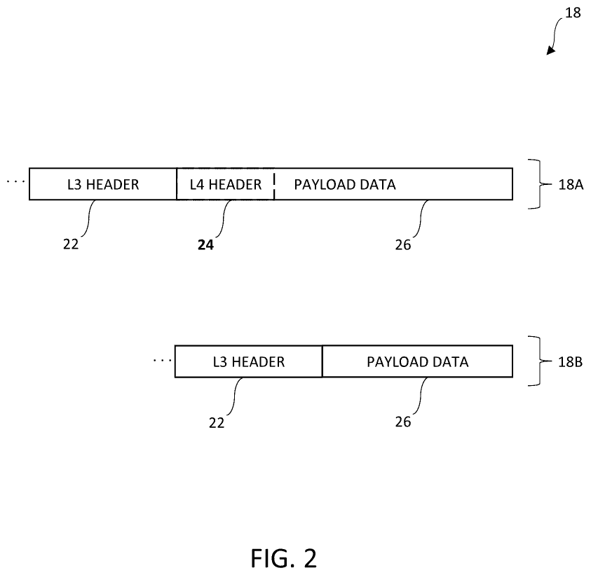

FIG. 2 is a diagram of illustrative leading and non-leading fragments. The leading fragment 18A may be a first of fragments 18 generated (e.g., by network device 10 in FIG. 1) from the original packet 16. The leading fragment 18A may be identifiable by its fragment offset header field having a value of zero. The fragment offset header field may indicate the position of the present fragment within the original packet with respect to the sequence of fragments generated for the original packet. A value of zero in the fragment offset header field may be indicative of the present fragment being the first in the sequence of fragments generated for the original packet. During the fragmentation process, leading fragment 18A may preserve (e.g., be generated to include) at least some network layer (OSI Layer 3 or L3) header fields 22 (and values therein) and transport layer (OSI Layer 4 or L4) header fields 24 (and values therein) from the original packet 16. As examples, leading fragment 18A may include a source IP address, a destination IP address, an L4 protocol, and an IP identification value, a source L4 port, and a destination L4 port, among other values.

Leading fragment 18A may also include a portion of the payload data from the original packet 16 (e.g., as payload data 26 in leading fragment 18A). In the context of leading fragment 18A being an IP fragment or more generally a network layer protocol data unit, L4 header fields 24 may sometimes be considered part of payload data 26, with L3 header fields 22 forming the header of the network layer protocol data unit.

One or more non-leading fragments 18B may be second, third, etc. of fragments 18 generated (e.g., by network device 10 in FIG. 1) from the original packet 16. A non-leading fragment 18B may be identified by its fragment offset having a non-zero value (e.g., a value greater than zero). During the fragmentation process, each non-leading fragment 18B may preserve (e.g., be generated to include) at least some network layer header fields 22 (and value therein) from the original packet 16, and may not preserve (e.g., may lack) L4 header fields from the original packet 16. As examples, non-leading fragment 18B may include a source IP address, a destination IP address, an L4 protocol, and an IP identification value, among other values. Non-leading fragment 18B may lack a source L4 port and a destination L4 port, among other values. Similar to leading fragment 18A, each non-leading fragment 18B may also include a corresponding portion of the payload data from the original packet 16 (e.g., as payload data 26 in each non-leading fragment 18B).

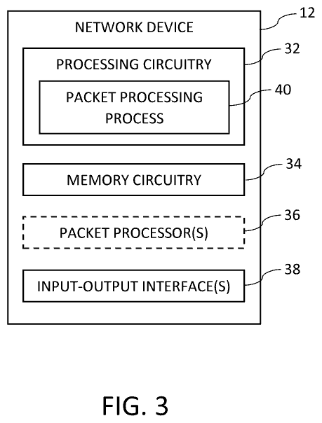

As described in connection with FIG. 1, a network device such as network device 12 may be configured to handle the processing of packet fragments 18. FIG. 3 is a diagram of an illustrative implementation of a network device. Configurations in which a network device of the type described in connection with FIG. 3 implements one or more of network device(s) of network 8 in FIG. 1, such as network device 12, are described herein as an example.

As shown in FIG. 3, network device 12 may include processing circuitry 32, memory circuitry 34, one or more packet processors 36 (if desired), and input-output interfaces 38 (e.g., formed using interface circuitry and one or more physical ports). In one illustrative arrangement, network device 12 may be or form part of a modular network device system (e.g., a modular switch system having removably coupled modules usable to flexibly expand characteristics and capabilities of the modular switch system such as to increase ports, provide specialized functionalities, etc.). In another illustrative arrangement, network device 12 may be a fixed-configuration network device (e.g., a fixed-configuration switch having a fixed number of ports and/or a fixed hardware configuration).

Processing circuitry 32 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors.

Processing circuitry 32 may run (e.g., execute) a network device operating system and/or other software/firmware that is stored on memory circuitry 34 communicatively coupled to and accessible by processing circuitry 32. Memory circuitry 34 may include one or more non-transitory (tangible) computer-readable storage media that store the operating system software and/or any other software code, sometimes referred to as program instructions, software, data, instructions, or code. As an example, the network device packet processing operations described herein and performed by network device 12 may be stored as (software) instructions on the one or more non-transitory computer-readable storage media (e.g., in portion(s) of memory circuitry 34). The corresponding processing circuitry (e.g., one or more processors of processing circuitry 32) may process (e.g., execute) the respective instructions to perform the corresponding network device packet processing operations.

Memory circuitry 34 may include non-volatile memory (e.g., flash memory, electrically-programmable read-only memory, a solid-state drive, hard disk drive storage, etc.), volatile memory (e.g., static random-access memory or dynamic random-access memory), removable storage devices (e.g., storage devices removably coupled to device 12), and/or other types of memory circuitry (e.g., content-addressable memory circuitry such as binary content-addressable memory and/or ternary content-addressable memory).

Processing circuitry 32 and at least the portion(s) of memory circuitry 34 as described above may sometimes be referred to collectively as control circuitry (e.g., collectively implementing a control plane of network device 12). Accordingly, processing circuitry 32 may sometimes be referred to as control plane processing circuitry 32 or control plane processor(s) 32. As just a few examples, processing circuitry 32 may execute network device control plane software such as operating system software, routing policy management software, routing protocol agents or processes, routing information base agents, and other control software, may be used to support the operation of protocol clients and/or servers (e.g., to form some or all of a communications protocol stack such as an Internet Protocol (IP) and Transmission Control Protocol (TCP) stack), may be used to support the operation of packet processor(s) 36, may store packet forwarding information, may execute packet processing software (e.g., packet processing process 40), and/or may execute other software instructions that control the functions of network device 12 and the other components therein.

In some illustrative configurations, network device 12 may include one or more packet processors 36 (e.g., implementing specialized packet processing hardware). Packet processor(s) 36 may be used to implement a data plane or forwarding plane of network device 12 and may therefore sometimes be referred to herein as data plane processor(s) 36 or data plane processing circuitry 36. Packet processor(s) 36 may include one or more processors such as programmable logic devices (e.g., field programmable gate array (FPGA) devices), application specific system processors (ASSPs), application specific integrated circuit (ASIC) processors, central processing units (CPUs), graphics processing units (GPUs), microprocessors, general-purpose processors, host processors, microcontrollers, digital signal processors, and/or other types of processors.

A packet processor 36 may receive incoming (ingress) network traffic via network interfaces 38 implemented on exterior-facing ports (and/or via internal interfaces), parse and analyze the received network traffic, process the network traffic based on traffic processing decision data, and selectively modify and forward (or drop) the network traffic based on the traffic processing decision data.

In some illustrative configurations, network device 12 may lack specialized packet processing hardware (e.g., one or more packet processors 36) and may perform packet processing by executing packet processing process 40 (e.g., instructions therefor stored on portion(s) of memory circuitry 34) on control plane processing circuitry 32. In general, as desired, packet processing process 40 (sometimes referred to as packet processing software 40) may be used to perform software packet processing in addition to or instead of using one or more specialized hardware packet processors 36 to perform packet processing.

To interact with external devices, external systems, and/or users, network device 12 may include input-output interfaces 38 formed from corresponding input-output devices (sometimes referred to as input-output circuitry or interface circuitry). Input-output interfaces 38 may include different types of communication interfaces such as Ethernet interfaces (e.g., formed from one or more Ethernet ports), optical interfaces (e.g., formed from removable optical modules containing optical transceivers), Bluetooth interfaces, Wi-Fi interfaces, and/or other network interfaces for connecting device 12 to the Internet, a local area network, a wide area network, a mobile network, generally network device(s) in these networks, and/or other computing equipment (e.g., end hosts, server equipment, user devices, etc.).

Some input-output interfaces 38 (e.g., those based on wireless communication) may be implemented using wireless communication circuitry (e.g., antennas, radio-frequency transceivers, radios, etc.). Some input-output interfaces 38 (e.g., those based on wired communication) may be implemented using physical ports. These physical ports may be configured to physically couple to and/or electrically connect to corresponding mating connectors of external components or equipment (e.g., cables, pluggable optical transceiver modules, etc.). Different ports may have different form-factors to accommodate different cables, different modules, different devices, or generally different external equipment.

As described in connection with FIGS. 1 and 2, the splitting of an original unfragmented packet 16 into fragmented packets 18 may result in the (first) leading fragment 18A having L4 header fields 24 (e.g., a source L4 port field and a destination L4 port field, among other fields), and may result in the (second, third, . . . , and/or last) non-leading fragment(s) 18B each lacking L4 header fields (e.g., lacking a source L4 port field and lacking a destination L4 port field, among other fields).

Without taking this into consideration, a network device may improperly process some packet fragments such as non-leading fragment(s) 18B, e.g., when processing the fragments based on network flow or generally based on L4 header information of the fragments. As an example, the network device may not be properly configured to perform network address translation (NAT) on the non-leading fragments because NAT may be configured based on network flows which rely on the five-tuple (e.g., including source L4 port and destination L4 port) identifying the network flow.

In general, issues may arise when any five-tuple or flow-based processing (e.g., processing based on flow cache, deep packet inspection, internet exit to provide internet connectivity, etc.) is being used to process the non-leading fragments. In view of this, it may be desirable for network devices of network 8, such as network device 12, to be configured to properly handle processing of packet fragments 18, especially L4 header-based processing of non-leading fragments 18B.

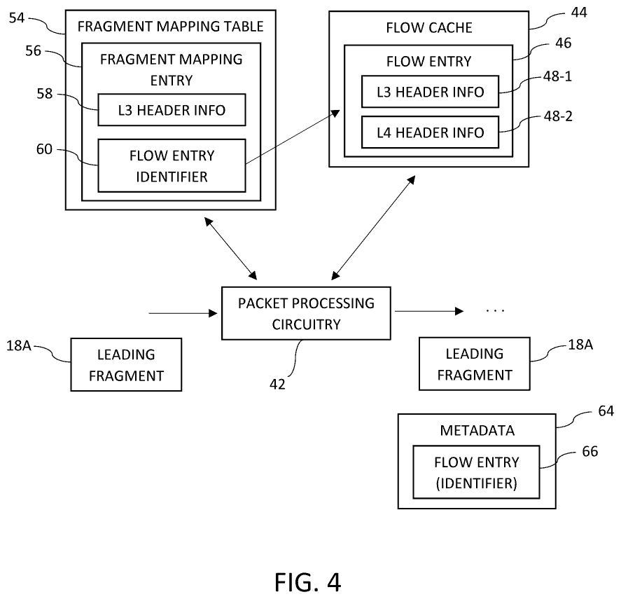

FIG. 4 is a diagram of illustrative packet processing circuitry in a network device, such as network device 12, configured to facilitate proper processing of packet fragments. In particular, the packet processing circuitry of FIG. 4, packet processing circuitry 42, may be implemented by (e.g., formed from) control plane processing circuitry 32, when executing packet processing software 40, and/or may be implemented by (e.g., formed from) one or more specialized packet processors 36. Configurations in which control plane processing circuitry 32, executing packet processing software 40, forms packet processing circuitry 42 are sometimes described herein as an illustrative example.

In general, packet processing circuitry 42 may form part of a packet processing pipeline of network device 12. Additional (upstream) packet processing circuitry may be coupled to the input(s) of packet processing circuitry 42 and/or additional (downstream) packet processing circuitry may be coupled to the output(s) of packet processing circuitry 42. Each packet processing circuitry may perform different functions in the packet processing pipeline and may be implemented by control plane processing circuitry 32 (executing packet processing software 40) and/or by packet processor(s) 36.

To facilitate processing of packet fragments and packets in general, packet processing circuitry 42 may maintain a flow cache such as flow cache 44 (sometimes referred to as flow table 44) containing one or more flow entries 46 (sometimes referred to as flow cache entries 46). Each flow entry 46 may correspond to (e.g., identify, be usable to identify, be associated with, etc.) a different network flow defined by header information shared across all packets (e.g., fragmented packets) in the same network flow. Packet processing circuitry 42 and/or packet processing circuitry downstream from packet processing circuitry 42 may refer to flow entries 46 for leading fragments 18A and/or the information therein to determine whether or not to perform certain operations, to determine parameters and/or manners in which certain operations should be performed, and/or to otherwise affect processing of packets on a per network flow basis.

As shown in FIG. 4, packet processing circuitry 42 may receive leading fragment 18A. When processing leading fragment 18A, packet processing circuitry 42 may provide (e.g., generate, populate, update, etc.) a corresponding flow entry 46 in flow cache 44 for the network flow to which all fragments 18 of packet 16 belong. Doing so may help facilitate downstream processing of leading fragment 18A (and non-leading fragments 18B) by downstream packet processing circuitry coupled to the output of packet processing circuitry 42.

Because leading fragment 18A includes L3 header fields and L4 header fields, packet processing circuitry 42 may generate and/or otherwise provide flow entry 46 with L3 header information 48-1 corresponding to (e.g., populated using) values in certain L3 header fields 22 of leading fragment 18A and containing L4 header information 48-2 corresponding to (e.g., populated using) values in certain L4 header fields 24 of leading fragment 18A.

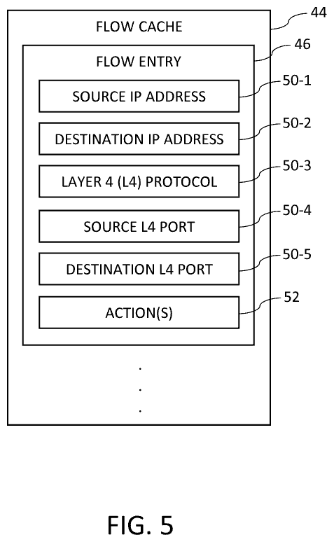

An illustrative flow cache such as flow cache 44 maintained by packet processing circuitry 42 is shown in FIG. 5. In particular, a portion of memory circuitry 34 in network device 10 may store flow cache 44 and one or more flow entries 46 therein. Packet processing circuitry 42 may generate, update, and/or otherwise maintain or manage flow cache 44 and entries 46 (e.g., based on received leading fragments, based on received unfragmented packets, etc.).

Configurations in which each flow entry 46 in flow cache 44 stores a five-tuple to identify a corresponding network flow to which all of the fragments of the original packet belong are sometimes described herein as an example. In particular, the five-tuple may include a source IP address 50-1 (e.g., part of L3 header information 48-1), a destination IP address 50-2 (e.g., part of L3 header information 48-1), a L4 protocol 50-3 (e.g., part of L3 header information 48-1 and/or part of L4 header information 48-2), a source L4 port 50-4 (e.g., part of L4 header information 48-2), and a destination L4 port 50-5 (e.g., part of L4 header information 48-2). Each flow entry 46 may also include and/or otherwise identify one or more actions 52 to be performed on the fragments or generally packets matching the 5-tuple of that flow entry 46. If desired, any flow entry 46 may include other information instead of or in addition to the above-mentioned header information for the five-tuple and the one or more actions.

Referring back to FIG. 4, while the identification of the flow entry 46 corresponding to (e.g., identifying a network flow of) leading fragment 18A may be sufficient to facilitate downstream processing of leading fragment 18A, without more, the same flow entry 46 may not be identifiable using later received non-leading fragments 18B which lack the corresponding L4 header fields (and the values therein) required to match to L4 header information 48-2 and identify the flow entry 46.

Accordingly, packet processing circuitry 42 may further maintain a fragment mapping table such as fragment mapping table 54 (sometimes referred to as lookup up table 54) containing one or more fragment mapping entries 56 (sometimes referred to as fragment mapping table entries 56). Each fragment mapping entry 56 may map any fragment 18 (e.g., non-leading fragments 18B) of the same original packet 16 to the flow entry 46 that identifies the network flow to which all fragments 18 and the original packet 16 belong. Packet processing circuitry 42 may therefore use fragment mapping table 54 to look up or otherwise identify the flow entry 46 for any non-leading fragment 18B (e.g., using a fragment mapping entry matching header values in the non-leading fragment 18B). Packet processing circuitry 42 and/or downstream packet processing circuitry may refer to the identified flow entries 46 for non-leading fragments 18B and/or the information therein to determine whether or not to perform certain operations, to determine parameters and/or manners in which certain operations should be performed, and/or to otherwise affect processing of packets on a per network flow basis.

To maintain fragment mapping table 54, when processing received leading fragment 18A, packet processing circuitry 42 may provide (e.g., generate, populate, update, etc.) a corresponding fragment mapping entry 56 in fragment mapping table 54. The inclusion or existence of fragment mapping entry 56, which is provided based on leading fragment 18A, may facilitate processing of any later received non-leading fragments 18B of the same original packet 16.

Each entry 56 may contain L3 header information 58 corresponding to (e.g., populated using) values in the L3 header fields 22 of leading fragment 18A and identifier 60 for the flow entry 46 that identifies the network flow to which all of leading fragment 18A and non-leading fragments 18B of packet 16 belong.

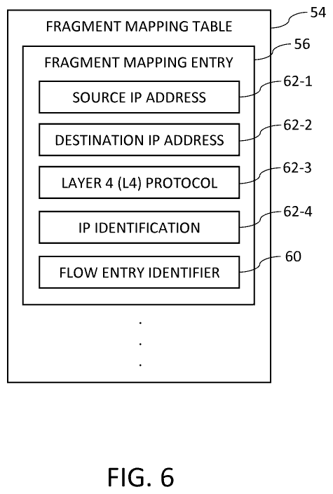

An illustrative fragment mapping table such as fragment mapping table 54 maintained by packet processing circuitry 42 is shown in FIG. 6. In particular, a portion of memory circuitry 34 in device 10 may store fragment mapping table 54 and one or more fragment mapping entries 56 therein. Packet processing circuitry 42 may generate, update, and/or otherwise maintain or manage entries 56 (e.g., based on received leading fragments).

Configurations in which L3 header information 58 of each fragment mapping entry 56 includes a source IP address 62-1, a destination IP address 62-2, an L4 protocol 62-3 (e.g., also present in a L3 header field 22), and an IP identification (IP-ID) value 62-4 are sometimes described herein as an illustrative example. These types of L3 header information 58 may be collectively usable to identify all fragments 18 of the same original packet 16. In other words, each of the leading fragment 18A and non-leading fragment(s) 18B for the same original packet 16 may share the same combination of source IP address 62-1, destination IP address 62-2, L4 protocol 62-3, and IP identification value 62-4. If desired, any fragment mapping entry 56 may include other information instead of or in addition to the above-mentioned types of L3 header information 58.

Each fragment mapping entry 56 may also include a flow entry identifier 60 to which L3 header information 58 is mapped. In other words, L3 header information 58 may be the key (fields) for the lookup operation using mapping table 54, while identifier 60 may be the result of the lookup operation when the entry 56 is determined to be a matching entry. Flow entry identifier 60 may be an identifier for a corresponding flow entry 46 that identifies the network flow to which all of the fragments 18 of the same original packet 16 belong (e.g., the same fragments 18 for which entry 56 is a matching entry). As such, the corresponding identified flow entry 46 may be used to facilitate downstream processing any of the fragments 18, or more specifically, non-leading fragments 18B (e.g., by providing flow information, L4 header information 48-2 for non-leading fragments 18B). As examples, flow entry identifier 60 may be a pointer, an index, and/or any other element or information indicative of or usable to identify the corresponding flow entry 46.

Referring back to FIG. 4, once packet processing circuitry 42 has updated flow cache 44 and fragment mapping table 54 using leading fragment 18A to include flow entry 46 and fragment mapping entry 56, packet processing circuitry 42 may have configured and prepared flow cache 44 and fragment mapping table 54 to be ready to process any later received non-leading fragments 18B of the same packet 16. Thereafter, packet processing circuitry 42 may provide (e.g., output, emit, etc.) leading fragment 18A along with metadata 64 to downstream packet processing circuitry (e.g., implemented by control plane processing circuitry 32, when executing packet processing process 40, and/or implemented by one or more packet processors 36).

Metadata 64 may include flow entry information 66 such as an indication or identifier of the flow entry 46 applicable to leading fragment 18A and/or information in the flow entry 46 (e.g., action(s) 52, L3 header information 48-1, L4 header information 48-2, etc.) applicable to leading fragment 18A (during downstream processing). Accordingly, based on flow entry information 66, the downstream packet processing circuitry may appropriately process leading fragment 18A (e.g., perform NAT for leading fragment 18A based on the flow entry 46, perform forwarding of leading fragment 18A based on the flow entry 46, perform mirror or sampling of leading fragment 18A based on the flow entry 46, etc.).

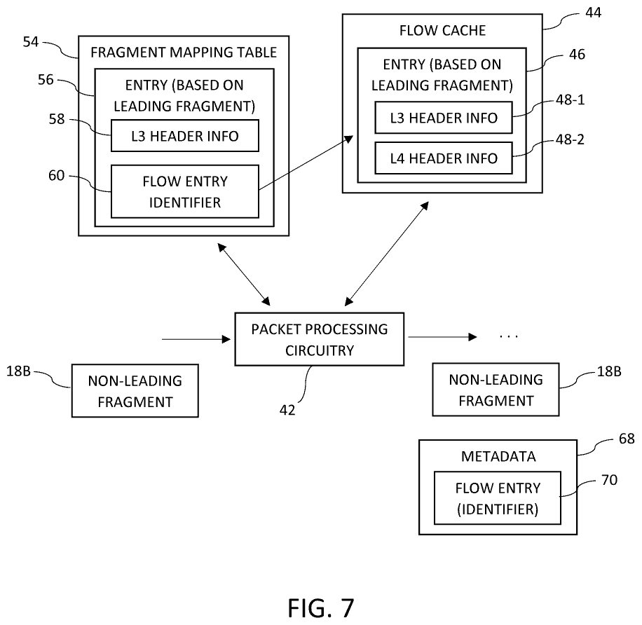

FIG. 7 is a diagram of illustrative packet processing circuitry (e.g., packet processing circuitry 42 in FIG. 4) configured to process a non-leading fragment after processing the leading fragment of the same original packet (e.g., in the manner described in connection with FIG. 4). Configurations in which the operations described in connection with FIG. 7 are performed after performing the operations described in connection with FIG. 4 are sometimes described herein as an illustrative example. If desired, the operations described in connection with FIG. 7 may be performed separately from the operations described in connection with FIG. 4.

As shown in FIG. 7, packet processing circuitry 42 may receive non-leading fragment 18B of original packet 16 (e.g., the same original packet 16 for leading fragment 18A of FIG. 4). Because non-leading fragment 18B lacks L4 header fields, packet processing circuitry 42 may not identify (e.g., may be unable to perform a lookup operation using flow cache 44 to identify) the corresponding flow entry 46 indicative of the network flow to which non-leading fragment 18B belongs. Packet processing circuitry 42 may instead process non-leading fragment 18B using fragment mapping table 54.

In particular, packet processing circuitry 42 may perform a lookup operation using the values of certain L3 header fields 22 of non-leading fragment 18B (e.g., as a lookup key) to identify the matching fragment mapping entry 56 containing the matching L3 header information 58. In such a manner, packet processing circuitry 42 may use flow entry identifier 60 in the matching fragment mapping entry 56 to identify flow entry 46 for non-leading fragment 18B.

Based on the flow entry 46 identified for non-leading fragment 18B, packet processing circuitry 42 may provide non-leading fragment 18B along with metadata 68 (obtained based on identifier 60) to downstream packet processing circuitry (e.g., implemented by control plane processing circuitry 32, when executing packet processing process 40, and/or implemented by one or more packet processors 36). In particular, metadata 68 may include flow entry information 70 such as an indication or identifier of the flow entry 46 applicable to non-leading fragment 18B and/or information in the flow entry 46 (e.g., action(s) 52, L3 header information 48-1, L4 header information 48-2, etc.) applicable to non-leading fragment 18B (during downstream processing). Accordingly, based on flow entry information 70, the downstream packet processing circuitry may appropriately process non-leading fragment 18B (e.g., perform NAT for non-leading fragment 18B based on the flow entry 46, perform forwarding of non-leading fragment 18B based on the flow entry 46, perform mirror or sampling of non-leading fragment 18B based on the flow entry 46 etc.). If desired, flow entry information 70 and flow entry information 66 (FIG. 4) may contain the same information or may generally include information based on the same identified flow entry 46.

In such a manner, even though non-leading fragment 18B lacks L4 header information and packet processing circuitry 42 cannot directly identify the matching flow entry 46 for non-leading fragment 18B based on a lookup operation using flow cache 44, packet processing circuitry 42 may use fragment mapping entry 56 to map L3 header information of non-leading fragment 18B to identifier 60 for the appropriate flow table 46, thereby indirectly identifying the appropriate flow table entry 46.

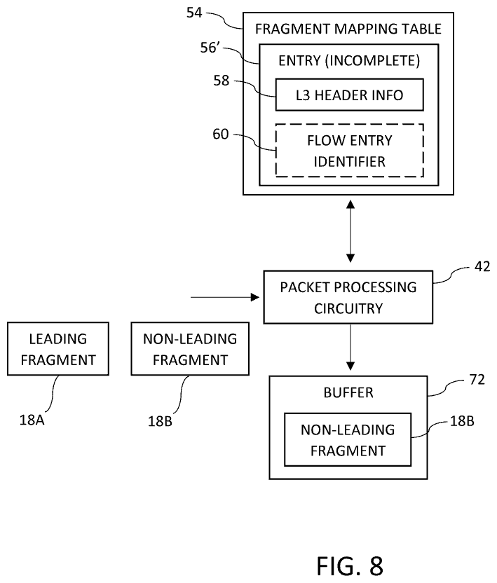

In some instances (e.g., when leading and non-leading fragments are conveyed via different network paths, by different network devices, under different conditions, with different random delays, etc.), a non-leading fragment of an original packet may arrive at a network device and is received and processed by packet processing circuitry prior to the leading fragment of the same original packet arriving at the network device and being received and processed by the packet processing circuitry. FIG. 8 is a diagram of illustrative packet processing circuitry (e.g., packet processing circuitry 42 in FIGS. 4 and 7) configured to receive and process a non-leading fragment of an original packet prior to (receiving and) processing a leading fragment of the same original packet.

Configurations in which the operations described in connection with FIG. 8 can be performed by the same packet processing circuitry as described in connection with FIGS. 4 and 7 are sometimes described herein as an illustrative example. In particular, fragments of different sets of original packets may be processed differently from each other by the same packet processing circuitry 42. For example, fragments for some original packets may be performed using the operations described in connection with FIGS. 4 and 7, while differently ordered fragments for other original packets may be performed using the operations described in connection with FIG. 8. If desired, the operations described in connection with FIG. 8 may be performed separately from and/or by different packet processing circuitry than that performing the operations described in connection with FIGS. 4 and 7.

In the example of FIG. 8, packet processing circuitry 42 may receive non-leading fragment 18B of original packet 16. Because packet processing circuitry 42 has yet to receive and process leading fragment 18A of the same original packet 16 (e.g., the operations described in connection with FIG. 4 has not yet occurred), no usable fragment mapping entry 56 to which non-leading fragment 18B will match exists in fragment mapping table 54. Accordingly, when packet processing circuitry 42 performs the lookup operation using the values of L3 header fields 22 of non-leading fragment 18B (as a lookup key), no corresponding (matching) entry 56 in fragment mapping table 54 may be found.

Based on the lack of a fragment mapping entry 56 that contains L3 header information matching non-leading fragment 18B, packet processing circuitry 42 may generate an incomplete fragment mapping entry 56′ that contains L3 header information 58 obtained from values of certain L3 header fields of non-leading fragment 18B. Because non-leading fragment 18B lacks L4 headers, packet processing circuitry 42 may be unable to identify a flow entry 46 for non-leading fragment 18B. The applicable flow entry 46 may also not yet exist in flow cache 44 (e.g., the operations described in connection with FIG. 4 have not yet occurred). As such, flow entry identifier 60 cannot be obtained, thereby resulting in entry 56′ being incomplete (e.g., being without flow entry identifier 60) and therefore unusable.

Packet processing circuitry 42 may store non-leading fragment 18B in buffer 72 (e.g., formed from memory circuitry 34) because without flow entry identifier 60 (and the corresponding flow entry 46), non-leading fragment 18B may not be properly processed by downstream packet processing circuitry. If desired, packet processing circuitry 42 may assign buffer 72 to incomplete entry 56′ or otherwise associate buffer 72 to incomplete entry 56′ such that the completion of entry 56′ (e.g., when entry 56 in FIG. 4 is provided) may trigger processing of any non-leading fragments 18B stored in buffer 72.

Any additional non-leading fragment(s) 18B of the same original packet 16 received by packet processing circuitry 42 after this first non-leading fragment 18B and prior to leading fragment 18A may similarly be stored in the same buffer 72. All of these non-leading fragments 18B may be awaiting completion of incomplete entry 56′ in buffer 72. To avoid buffering one or more non-leading fragments 18B indefinitely (e.g., in scenarios in which leading packet 18A is never received, cannot be properly processed, etc.), packet processing circuitry 42 may purge buffer 72 of the one or more non-leading fragments 18B after a period of time and/or when other criteria are met, if desired.

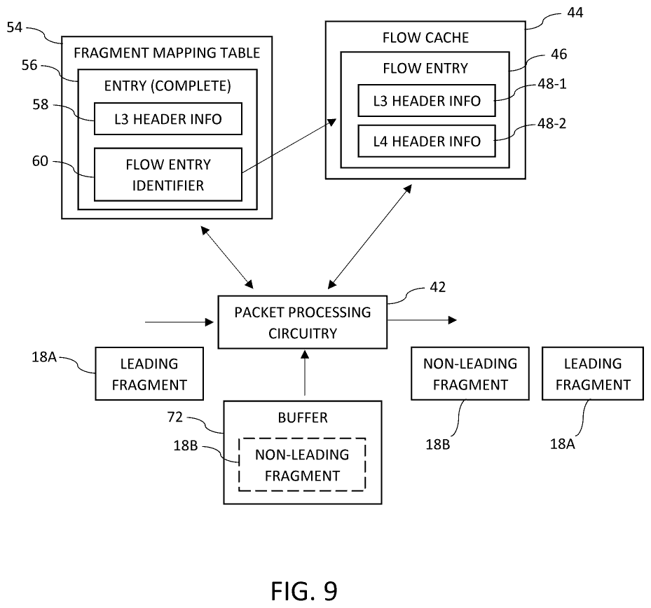

FIG. 9 is a diagram of illustrative packet processing circuitry (e.g., packet processing circuitry 42 in FIG. 8) configured to process a leading fragment after a non-leading fragment has been received and buffered (e.g., in the manner described in connection with FIG. 8). Configurations in which the operations described in connection with FIG. 9 are performed after performing the operations described in connection with FIG. 8 are sometimes described herein as an illustrative example. If desired, the operations described in connection with FIG. 9 may be performed separately from the operations described in connection with FIG. 8.

As shown in FIG. 9, packet processing circuitry 42 may receive leading fragment 18A of original packet 16 (e.g., the same original packet 16 for non-leading fragment 18B of FIG. 8). After receiving leading fragment 18A, packet processing circuitry 42 may perform similar operations as described in connection with FIG. 4 to provide (e.g., generate) flow entry 46 for the network flow to which leading and non-leading fragments 18 of original packet 16 belong and to provide a complete and usable fragment mapping entry 56 (e.g., to complete incomplete entry 56′ of FIG. 8). In particular, packet processing circuitry 42 may perform a lookup operation (e.g., using values in corresponding L3 header fields in leading fragment 12A) to identify an incomplete fragment mapping entry 56′ (FIG. 8) and may complete the entry by providing flow entry identifier 60 (e.g., a pointer or other identifier that identifies the entry 46 generated based on processing leading fragment 18A).

As similarly described in connection with FIG. 4, after updating flow cache 44 and fragment mapping table 54 based on leading fragment 18A, packet processing circuitry 42 may provide leading fragment 18A to downstream packet processing circuitry (e.g., along with metadata 64 containing flow entry information 68 in FIG. 4) for downstream processing.

Based on fragment mapping table entry 56 being completed (e.g., including flow entry identifier 60), processing of non-leading fragment(s) 18B stored in buffer 72 may be triggered. Accordingly, packet processing circuitry 42 may provide non-leading fragment 18B to downstream packet processing circuitry (e.g., along with metadata 68 containing flow entry information 70 in FIG. 7 obtained based on the newly populated identifier 60).

While a single non-leading fragment of the original packet 16 is shown in FIGS. 8 and 9, this is merely illustrative. In general, any additional non-leading fragment(s) 18B of the same original packet 16 received prior to leading fragment 18A may be processed and buffered at buffer 72 in the same manner as described in connection with FIG. 8. Following the reception and processing of leading fragment 18A and consequently the inclusion (e.g., completion) of corresponding entries 46 and 56 in flow cache 44 and fragment mapping table 54, respectively, each of the non-leading fragments stored at buffer 72 may be processed and output along with corresponding metadata 70 (e.g., containing information on the applicable flow entry 46).

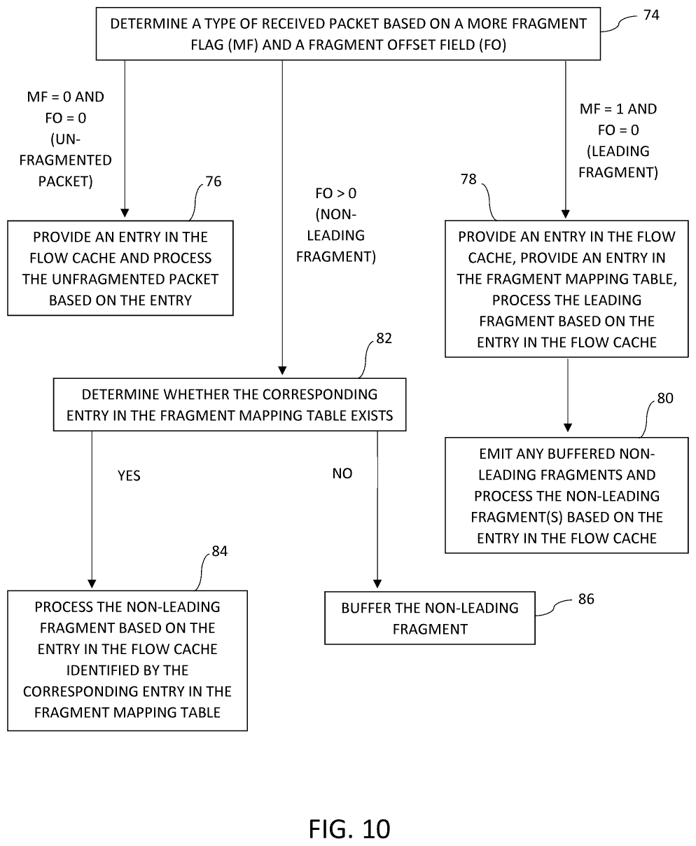

FIG. 10 is a flowchart of illustrative operations for processing different types of packets such as an unfragmented packet, a leading fragmented packet (sometimes referred to as a leading fragment), and a non-leading fragmented packet (sometimes referred to as a non-leading fragment). Configurations in which the operations described in connection with FIG. 10 are performed by network device 12, and more specifically, by packet processing circuitry 42 (e.g., as described in connection with FIGS. 4-9) are sometimes described herein as illustrative examples. If desired, other network devices or other computing equipment in the networking system of FIG. 1 may similarly perform the operations described in connection with FIG. 10.

Configurations in which the illustrative operations described in connection with FIG. 10 are performed using processing circuitry of a computing device (e.g., control plane processing circuitry 32) by executing, on the processing circuitry, software instructions stored on corresponding memory circuitry of the computing device (e.g., non-transitory computer-readable storage media of memory circuitry 34) are sometimes described herein as an example. If desired, instead of or in addition to the software-executing processing circuitry, certain application-specific or specialized processor(s) such as packet processor(s) 36 may perform some or all of the operations described in connection with FIG. 10.

At block 74, one or more processors (e.g., packet processing circuitry 42) may determine a type of packet being received by the one or more processors based on a more fragment flag and a fragment offset field in the L3 header of the received packet. The more fragment flag may indicate whether or not there are any additional fragments generated from the same original packet subsequent to the present packet or fragment. The fragment offset field may indicate the position of the present fragment within the original packet with respect to the sequence of fragments generated for the original packet.

In a first scenario, the one or more processors may receive a packet with a more fragment flag that is cleared or unset (e.g., having a binary value of 0) and a fragment offset field having a value of 0. Based on these values for the more fragment flag and the fragment offset field, the one or more processors may determine that the received packet is a non-fragmented (or unfragmented) packet and may proceed with processing based on block 76.

At block 76, the one or more processors may provide (e.g., generate, if not already present) an entry in the flow cache (e.g., flow cache 44) and process (e.g., output for downstream processing of) the received non-fragmented packet based on the provided entry (e.g., using the entry and/or an indication of the entry as metadata). Because the received packet is not fragmented, modification of a fragment mapping table to include a corresponding entry (e.g., as described in connection with FIGS. 4, 8, and 9) to facilitate processing of any earlier and/or later received non-leading fragments may not be necessary.

In a second scenario, the one or more processors may receive a packet with a more fragment flag that is set (e.g., having a binary value of 1) and a fragment offset field having a value of 0. Based on these values for the more fragment flag and the fragment offset field, the one or more processors may determine that the received packet is a leading fragment of multiple fragments of an original packet (e.g., leading fragment 18A of original packet 16) and may proceed with processing based on block 78.

At block 78, the one or more processors may provide an entry in the flow cache (e.g., generate, if not already present, an applicable flow entry 46 in flow cache 44), provide an entry in the fragment mapping table (e.g., generate and/or update a fragment mapping entry 56 in fragment mapping table 54), and process (e.g., output for downstream processing of) the received leading fragment based on the provided entry in the flow cache (e.g., using the flow entry and/or an indication of the flow entry as metadata). As examples, the one or more processors may perform the operations for processing leading fragment 18A as described in connection with FIG. 4 or FIG. 9 when performing the operations of block 78.

Depending on the order of the leading and non-leading fragments being received and processed, there may or may not be any buffered non-leading fragments (e.g., fragments 18B in buffer 72) when the one or more processors perform the operations of block 78. If any non-leading fragments were buffered prior to reception of the leading fragment, the one or more processors may, at block 80, output any buffered non-leading fragments for downstream processing of the non-leading fragment(s) based on the entry in the flow cache (e.g., the flow cache entry provided at block 78). As an example, the one or more processors may perform the operations of processing buffered non-leading fragments 18B as described in connection with FIG. 9 when performing the operations of block 80.

In a third scenario, the one or more processors may receive a packet with a fragment offset field having a value greater than 0 (and having a set or cleared more fragment flag). Based on the non-zero value in the fragment offset field, the one or more processors may determine that the received packet is a non-leading fragment of multiple fragments of an original packet (e.g., non-leading fragment 18B of original packet 16) and may proceed with processing based on block 82.

At block 82, the one or more processors may determine whether or not a completed and usable entry matching the received non-leading fragment exists in the fragment mapping table (e.g., whether or not a matching entry 56 exists in fragment mapping table 54). The completed fragment mapping entry matching the received non-leading fragment may help facilitate processing of the non-leading fragment by identifying the corresponding flow table entry (e.g., the matching flow entry 46 in flow cache 44) that would otherwise not be identifiable because of the lack of L4 headers in the non-leading fragment.

Based on the fragment mapping table including a completed entry for the received non-leading fragment (e.g., indicative of the processing of a leading fragment as described in connection with block 78 having already been performed), processing may proceed to block 84. At block 84, the one or more processors may process the received non-leading fragment (e.g., non-leading fragment 18B) based on the entry in the flow cache identified by the corresponding entry in the fragment mapping table (e.g., the flow entry 46 in flow cache 44 identified by identifier 60 in the matching fragment mapping entry 56 in fragment mapping table 54). As an example, the one or more processors may perform the operations of processing received non-leading fragment 18B as described in connection with FIG. 7 when performing the operations of block 84.

Based on the fragment mapping table lacking a completed entry for the received non-leading fragment (e.g., indicative of the processing of a leading fragment as described in connection with block 78 not having been performed yet), processing may proceed to block 86. At block 86, the one or more processors may buffer the received non-leading fragment, which will be emitted and processed as described in connection with block 80. As an example, the one or more processors may perform the operations of processing received non-leading fragment 18B as described in connection with FIG. 8 when performing the operations of block 86.

If desired, the one or more processors may provide a partially completed fragment mapping entry (e.g., entry 56′) and associate the incomplete entry with any buffered non-leading fragments (e.g., associate entry 56′ with buffer 72 assigned to the non-leading fragments 18B of the same original packet 16) that would be processed using that fragment mapping entry to trigger processing of the buffered non-leading fragment(s) upon completion of the fragment mapping entry. In other words, configured in this manner, the one or more processors may be configured to perform the operations of block 80 in response to performing the operations of block 78.

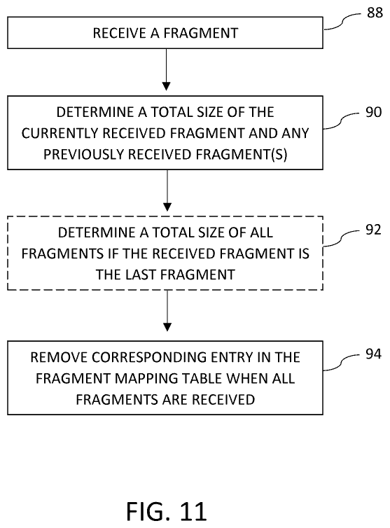

To ensure that there is no buildup of unnecessary fragment mapping entries in the fragment mapping table, packet processing circuitry may manage the life cycle of the fragment mapping entries. FIG. 11 is a flowchart of illustrative operations for managing entries in a fragment mapping table (e.g., entries 56 in fragment mapping table 54). Configurations in which the operations described in connection with FIG. 11 are performed by network device 12, and more specifically, by packet processing circuitry 42 (e.g., as described in connection with FIGS. 4-9) are sometimes described herein as illustrative examples. If desired, other network devices or other computing equipment in the networking system of FIG. 1 may similarly perform the operations described in connection with FIG. 11.

Configurations in which the illustrative operations described in connection with FIG. 11 are performed using processing circuitry of a computing device (e.g., control plane processing circuitry 32) by executing, on the processing circuitry, software instructions stored on corresponding memory circuitry of the computing device (e.g., non-transitory computer-readable storage media of memory circuitry 34) are sometimes described herein as an example. If desired, instead of or in addition to the software-executing processing circuitry, certain application-specific or specialized processor(s) such as packet processor(s) 36 may perform some or all of the operations described in connection with FIG. 11.

At block 88, one or more processors (e.g., packet processing circuitry 42) may receive a packet fragment. The received packet fragment may be the (first) leading fragment or the (second, third, . . . , last) non-leading fragment. In other words, the one or more processing circuitry may perform the operations described in connection with blocks 90, 92, and 94 for each received packet fragment.

At block 90, the one or more processors may determine a total (cumulative) size of the currently received fragment and any previously received fragment(s) of a particular original packet 16 (i.e., of the same original packet). As an example, the size of each fragment may be a payload size obtained by subtracting the header length (e.g., the IP or L3 header length obtained from the fragment) from the total length of the fragment (e.g., obtained from the fragment). The payload sizes of the currently and previously received fragments may be summed to obtain the total size (e.g., the total payload size) of the currently received fragment and any previously received fragment(s) of the particular packet 16.

At block 92, the one or more processors may determine a total size of all fragments of the particular packet 16 if the received fragment is the last fragment of the particular packet 16. In other words, the operations described in connection with block 92 may be performed in response to the one or more processors determining that the received packet is the last(-generated) fragment of the particular packet 16 and may otherwise be omitted. In particular, the one or more processors may determine that the received fragment is the last fragment based on the received fragment having a more fragment flag that is cleared or unset and having a fragment offset field with a non-zero value.

The last fragment of the particular packet 16 may carry header information usable to determine the total size of all of the fragments of the particular packet 16. Accordingly, the one or more processors may sum the fragment offset value (e.g., obtained from the last fragment) with the total length of the fragment (e.g., obtained from the last fragment) and subtract the header length (e.g., the IP or L3 header length obtained from the last fragment) from the sum of the fragment offset value and the total fragment length to obtain the total size (e.g., the total payload size) of all fragments of the particular packet 16.

At block 94, the one or more processors may remove the corresponding entry in the fragment mapping table (e.g., remove the matching fragment mapping entry 56 from fragment mapping table 54) when all fragments of the particular packet 16 have been received. In particular, the one or more processors may determine that all of the fragments have been received based on the total size of the currently and previously received fragments of the particular packet 16 as determined at block 90 matching the total size of all of the fragments of the particular packet 16 as determined at block 92.

The removal of unnecessary fragment mapping entries based on the operations described in connection with FIG. 11 is merely illustrative. If desired, other types of processing and/or other criteria may be used, additionally or alternatively, to cause the removal of (unnecessary) fragment mapping entries from the fragment mapping table.

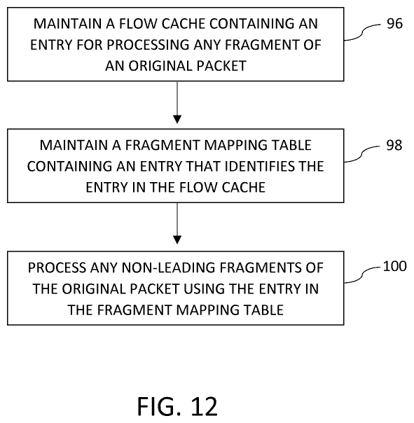

FIG. 12 is a flowchart of illustrative operations for facilitating the appropriate processing of non-leading fragments. Configurations in which the operations described in connection with FIG. 12 are performed by network device 12, and more specifically, by packet processing circuitry 42 (e.g., as described in connection with FIGS. 4-9) are sometimes described herein as illustrative examples. If desired, other network devices or other computing equipment in the networking system of FIG. 1 may similarly perform the operations described in connection with FIG. 12.

Configurations in which the illustrative operations described in connection with FIG. 12 are performed using processing circuitry of a computing device (e.g., control plane processing circuitry 32) by executing, on the processing circuitry, software instructions stored on corresponding memory circuitry of the computing device (e.g., non-transitory computer-readable storage media of memory circuitry 34) are sometimes described herein as an example. If desired, instead of or in addition to the software-executing processing circuitry, certain application-specific or specialized processor(s) such as packet processor(s) 36 may perform some or all of the operations described in connection with FIG. 12.

At block 96, one or more processors (e.g., packet processing circuitry 42) may maintain a flow cache (e.g., on memory circuitry 34) containing an entry for processing any fragments of an original packet. As an example, the flow cache such as flow cache 44 may be maintained (e.g., updated, modified, kept in storage on memory circuitry 34, etc.) by the one or more processors performing some or all of the operations described in connection with FIGS. 4, 5, 7, 9, and/or 10.

At block 98, the one or more processors may maintain a fragment mapping table containing an entry (e.g., for matching on non-leading fragments of the original packet) that identifies the corresponding entry in the flow cache. As an example, the fragment mapping table such as fragment mapping table 54 may be maintained (e.g., updated, modified, kept in storage on memory circuitry 34, etc.) by the one or more processors performing some or all of the operations described in connection with FIGS. 4, 6, 7, 8, 9, 10, and/or 11.

At block 100, the one or more processors (e.g., upstream packet processing circuitry 42, downstream packet processing circuitry, and/or generally packet processing circuitry in a packet processing pipeline) may process any non-leading fragments of the original packet using the entry in the fragment mapping table (and consequently the identified entry in the flow cache). As an example, any non-leading fragments along with corresponding metadata (based on the identified entry in the flow cache) may be passed from upstream packet processing circuitry 42 to downstream packet processing circuitry by the one or more processors performing some or all of the operations described in connection with FIGS. 7, 9, and/or 10.

The methods and operations described above in connection with FIGS. 1-12 may be performed by the components of the network device(s) (e.g., network device 12) or other computing equipment using software, firmware, and/or hardware (e.g., dedicated circuitry or hardware). Software code for performing these operations may be stored on non-transitory computer-readable storage media (e.g., tangible computer-readable storage media) stored on one or more of the components of the network device(s) or other computing equipment. The software code may sometimes be referred to as software, data, instructions, program instructions, or code. The non-transitory computer-readable storage media may include hard drives (electro-mechanical data storage devices), other non-volatile memory such as solid-state drives, non-volatile random-access memory (NVRAM), removable flash drives or other removable media, and/or volatile memory such as random-access memory or other types of volatile memory. Software stored on the non-transitory computer-readable storage media may be executed by processing circuitry on the network device(s) or other computing equipment.

The foregoing is merely illustrative and various modifications can be made to the described embodiments. The foregoing embodiments may be implemented individually or in any combination.

What is claimed is:

1. A network device comprising:
memory circuitry; and
packet processing circuitry coupled to the memory circuitry and configured to:
maintain a flow cache on the memory circuitry that contains a flow cache entry associated with a network flow; and
maintain a fragment mapping table on the memory circuitry that contains a fragment mapping table entry that maps network layer header information of a packet fragment to the flow cache entry.

2. The network device defined in claim 1, wherein the flow cache entry includes transport layer header information and at least some of the network layer header information and wherein the transport layer header information and the at least some of the network layer header information define the network flow.

3. The network device defined in claim 2, wherein the fragment mapping table entry includes the network layer header information and an identifier for the flow cache entry.

4. The network device defined in claim 1, wherein the packet processing circuitry is configured to receive a leading fragment of multiple packet fragments split from an original packet and is configured to provide the fragment mapping table entry by processing the leading fragment.

5. The network device defined in claim 4, wherein the packet processing circuitry is configured to receive a non-leading fragment of the multiple packet fragments split from the original packet and is configured to look up network layer header field values of the non-leading fragment in the fragment mapping table to identify the fragment mapping table entry.

6. The network device defined in claim 5, wherein the packet processing circuitry is configured to provide the non-leading fragment along with metadata based on the fragment mapping table entry for downstream processing of the non-leading fragment.

7. The network device defined in claim 1, wherein the packet processing circuitry is configured to receive a non-leading fragment of multiple packet fragments split from an original packet prior to the fragment mapping table containing the fragment mapping table entry and is configured to buffer the non-leading fragment.

8. The network device defined in claim 7, wherein the packet processing circuitry is configured to receive a leading fragment of the multiple packet fragments split from the original packet while the non-leading fragment is buffered and is configured to provide the fragment mapping table entry by processing the leading fragment.

9. The network device defined in claim 8, wherein the packet processing circuitry is configured to output the non-leading fragment for downstream processing based on the fragment mapping table entry being provided and wherein the non-leading fragment is output along with metadata based on the fragment mapping table entry.

10. The network device defined in claim 1, wherein the fragment mapping table entry includes a source Internet Protocol (IP) address, a destination IP address, a transport layer (L4) protocol, and an IP identification value that are collectively usable to identify each of multiple fragments split from an original packet.

11. The network device defined in claim 10, wherein the flow cache entry includes the source IP address, the destination IP address, the L4 protocol, a source L4 port, and a destination L4 port that collectively define the network flow.

12. The network device defined in claim 11, wherein the packet processing circuitry is configured to process a non-leading fragment of the multiple packet fragments split from the original packet based on the flow cache entry using the fragment mapping table entry, wherein the non-leading fragment includes the source IP address, the destination IP address, the L4 protocol, and the IP identification value, and wherein the non-leading fragment lacks the source L4 port and the destination L4 port.

13. The network device defined in claim 12, wherein the packet processing circuitry is configured to process a leading fragment of the multiple packet fragments split from the original packet based on the flow cache entry, wherein the leading fragment includes the source IP address, the destination IP address, the L4 protocol, the IP identification value, the source L4 port, and the destination L4 port.

14. The network device defined in claim 1, wherein the packet processing circuitry is configured to remove the fragment mapping table entry based on all packet fragments associated with the fragment mapping table entry being received by the packet processing circuitry.

15. A network device comprising:
memory circuitry; and
packet processing circuitry coupled to the memory circuitry and configured to:
receive a non-leading fragment of multiple fragments split from an original packet; and
process the non-leading fragment based on a fragment mapping table entry that identifies a flow cache entry for the non-leading fragment.

16. The network device defined in claim 15, wherein the packet processing circuitry is configured to receive the leading fragment of the multiple fragments split from the original packet and is configured to provide the fragment mapping table entry by processing the received leading segment.

17. The network device defined in claim 15, wherein the flow cache entry includes Layer 4 (L4) header information and wherein the non-leading fragment lacks L4 header fields.

18. A method for processing fragments of a packet, the method comprising:
receiving a leading fragment of the packet, the leading fragment having network layer header information and transport layer header information;
providing an entry in a flow table based on the network layer header information and based on the transport layer header information;
providing an entry in a mapping table that identifies the entry in the flow table based on the network layer header information; and
processing a non-leading fragment of the packet at least in part by identifying the entry in the flow table based on the network layer header information of the non-leading fragment.

19. The method of claim 18 further comprising:
receiving the non-leading fragment of the packet after receiving the leading fragment of the packet, wherein identifying the entry in the flow table based on the network layer header information of the non-leading fragment comprises looking up the network layer header information of the non-leading fragment in the mapping table to identify the entry in the mapping table.

20. The method of claim 18 further comprising:
receiving the non-leading fragment prior to receiving the leading fragment; and
buffering the non-leading fragment of the packet, wherein processing the non-leading fragment of the packet at least in part by identifying the entry in the flow table based on the network layer header information of the non-leading fragment occurs after the leading fragment is received.
